(19) United States
(12) Patent Application Publication
(10) Pub. No.: US 2025/0239705 A1
(43) Pub. Date: Jul. 24, 2025

(54) POWER STORAGE DEVICE

(71) Applicant: TOYOTA JIDOSHA KABUSHIKI KAISHA, Toyota-shi (JP)

(72) Inventors: Kotaro Horiguchi, Nagoya-shi (JP); Takeharu Matsuno, Nagakute-shi (JP); Hongbi Min, Toyota-shi (JP); Satoshi Inukai, Nagoya-shi (JP)

(73) Assignee: TOYOTA JIDOSHA KABUSHIKI KAISHA, Toyota-shi (JP)

(21) Appl. No.: 18/986,951

(22) Filed: Dec. 19, 2024

(30) Foreign Application Priority Data
Jan. 19, 2024 (JP) 2024-006554

(51) Int. Cl. H01M 50/233; H01M 50/204; H01M 50/249; H01M 50/289

(52) U.S. Cl. CPC H01M 50/233; H01M 50/249; H01M 50/289; H01M 50/204

(57) ABSTRACT

The power storage device includes a power storage module and a case. The power storage module includes a plurality of cells. The case includes a first wall, a pair of second walls, and a first reinforcing member. The first reinforcing member is provided on the first wall. The first reinforcing member extends along a first direction. The first reinforcing member is more rigid than the first wall and the pair of second walls. The first reinforcing member includes a first region and a second region. The first region extends in the first direction. The second region is aligned with the first region in the first direction. The second region extends in the first direction. The second region is less rigid than the first region.

### CROSS REFERENCE TO RELATED APPLICATIONS

This non-provisional application is based on Japanese Patent Application No. 2024-006554 filed on Jan. 19, 2024 with the Japan Patent Office, the entire contents of which are hereby incorporated by reference.

### BACKGROUND

### Field

The present disclosure relates to a power storage device.

### Description of the Background Art

Japanese Patent Laying-Open No. 2018-144700 discloses a battery pack that houses therein a battery. A reinforcing frame is disposed on at a rear edge of the battery pack and configured to extend in the width direction of the vehicle at least along a rear end surface.

### SUMMARY

In the conventional power storage device, when a load is applied to the reinforcing member, the reinforcing member may be deformed in an arc shape with both ends of the reinforcing member acting as fulcrums. The deformed reinforcing member and a part of the battery pack adjacent to the deformed reinforcing member may apply a local load to the cells of the power storage module housed in the battery pack.

The present disclosure has been made in view of the above-mentioned problems, and an object of the present disclosure is to provide a power storage device capable of preventing a local load from being applied to cells of a power storage module.

The power storage device according to an aspect of the present disclosure includes a power storage module and a case. The power storage module includes a plurality of cells. The plurality of cells are stacked on each other in the first direction. The case houses the power storage module. The case includes a first wall, a pair of second walls, and a first reinforcing member. The first wall is located at least on one side of the power storage module in a second direction intersecting the first direction. The first wall extends along the first direction. The pair of second walls are located on both sides of the power storage module in the first direction, respectively. The pair of second walls extend along the second direction. The pair of second walls are connected to both ends of the first wall, respectively. The first reinforcing member is provided on the first wall. The first reinforcing member extends along the first direction. The first reinforcing member is more rigid than the first wall and the pair of second walls. The first reinforcing member includes a first region and a second region. The first region extends in the first direction. The second region is aligned with the first region in the first direction. The second region extends in the first direction. The second region is less rigid than the first region.

According to the configuration described above, when a load is applied to the second region of the first reinforcing member from one side of the second direction, the entire second region is displaced in the second direction toward the power storage module. The displaced second region comes into contact with the plurality of cells stacked in the first direction together with the first wall. Therefore, the load applied to the second region of the first reinforcing member can be distributed to the plurality of cells. In other words, according to the configuration described above, it is possible to prevent the first reinforcing member from being deformed in an arc shape with the pair of second walls acting as fulcrums. Thus, it is possible to prevent a local load from being applied to the cells of the power storage module by the deformed first reinforcing member and the first wall.

In the power storage device mentioned above, the second region of the first reinforcing member may be located on an outer surface of the first wall in the middle of the first direction.

According to the configuration described above, since the second region is located at a position relatively far from the pair of second walls, the entire second region is more easily displaced when a load is applied to the second region.

Accordingly, it is possible to further prevent the first reinforcing member and the first wall from being deformed in an arc shape. The load applied to the second region of the first reinforcing member may be dispersed by the plurality of cells.

Further, the length of the second region in the first direction may be half or more of the length of the first reinforcing member.

According to the configuration described above, even when the position of a maximum load applied to the first reinforcing member is unevenly distributed in the first direction, the entire second region may be displaced by the load applied to the first reinforcing member. Therefore, the load applied to the first reinforcing member can be effectively distributed to the plurality of cells.

In the power storage device mentioned above, the case may further include a pair of second reinforcing members. The pair of second reinforcing members may be provided on the pair of second walls, respectively. The pair of second reinforcement members may be more rigid than the first wall and the pair of second walls. The second region may be less rigid than the pair of second reinforcement members. According to the configuration described above, the strength of the second wall can be improved by the second reinforcing member, and thereby the strength of the case can be improved. Since the first reinforcing member includes the second region which is less rigid than the second reinforcing member, it is possible to prevent the first reinforcing member from being deformed in an arc shape with the pair of second reinforcing members acting as fulcrums.

Further, the pair of second reinforcing members may be spaced apart from the first reinforcing member. According to this configuration, it is possible to further prevent the first reinforcing member from being deformed in an arc shape with the pair of second reinforcing members acting as fulcrums.

In the power storage device mentioned above, the case may further include a third wall. The third wall may be located on the other side of the power storage module in the second direction. The third wall may extend along the first direction. The pair of second walls may be connected to both ends of the third wall, respectively. The case may further include a third reinforcing member. The third reinforcing member may be provided on the third wall. The third reinforcing member may extend along the first direction. The third reinforcing member may be more rigid than the third wall and the pair of second walls. The second region may be less rigid than the third reinforcing member.

According to the configuration described above, it is possible to improve the rigidity of the entire case in the first direction. When a load is applied from the side of the third reinforcing member in the second direction, the second region of the first reinforcing member is deformed, which prevents the third reinforcing member and the third wall from being deformed in an arc shape.

In the power storage device mentioned above, each of the plurality of cells may include an electrode assembly and a cell case. The electrode assembly may include a positive electrode layer, a negative electrode layer, and a separator. The cell case may house the electrode assembly. The positive electrode layer and the negative electrode layer may be stacked in the first direction with the separator interposed therebetween.

When a cell having the above-described configuration is compressed to deform in the second direction, an internal short circuit is likely to occur. However, since the load applied to one cell is reduced by the second region, the compressive deformation in the second direction is prevented. Therefore, it is possible to prevent an internal short circuit from occurring in the cell.

In the power storage device mentioned above, each of the plurality of cells may include an electrode assembly and a cell case. The electrode assembly may include a positive electrode layer, a negative electrode layer, and a separator. The separator may be interposed between the positive electrode layer and the negative electrode layer. The cell case may house the electrode assembly. The electrode assembly may be wound about an axis in a direction orthogonal to the first direction.

When a cell having the above-described configuration is compressed to deform in a direction orthogonal to the first direction, an internal short circuit is likely to occur. However, since the load applied to one cell is reduced by the second region, the compressive deformation in the direction orthogonal to the first direction is prevented. Therefore, it is possible to prevent an internal short circuit from occurring in the cell.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic diagram illustrating a state in which a power storage device according to an embodiment of the present disclosure is mounted on a vehicle;

FIG. 2 is a perspective view illustrating a power storage device according to an embodiment of the present disclosure;

FIG. 3 is a partial perspective view illustrating a region III of FIG. 2 from a different angle;

FIG. 4 is a schematic plan view partially illustrating an internal structure of the power storage device;

FIG. 5 is an exploded perspective view of a cell;

FIG. 6 is a partial cross-sectional view illustrating an electrode assembly of FIG. 5 taken along line VI-VI;

FIG. 7 is an exploded perspective view illustrating a cell according to a modification;

FIG. 8 is a schematic perspective view partially illustrating a configuration of a power storage device;

FIG. 9 is a schematic plan view illustrating a power storage device to which a load is applied;

FIG. 10 is a perspective view partially illustrating a configuration of a power storage device according to a modification;

FIG. 11 is a perspective view partially illustrating a configuration of a power storage device according to another modification; and

FIG. 12 is a schematic cross-sectional view illustrating a first reinforcing member of FIG. 11 taken along line XII-XII.

### DESCRIPTION OF THE PREFERRED EMBODIMENTS

Hereinafter, a power storage device according to an embodiment of the present disclosure will be described with reference to the drawings. In the following description of the present disclosure, the same or corresponding parts in the drawings are denoted by the same reference numerals, and the description thereof will not be repeated.

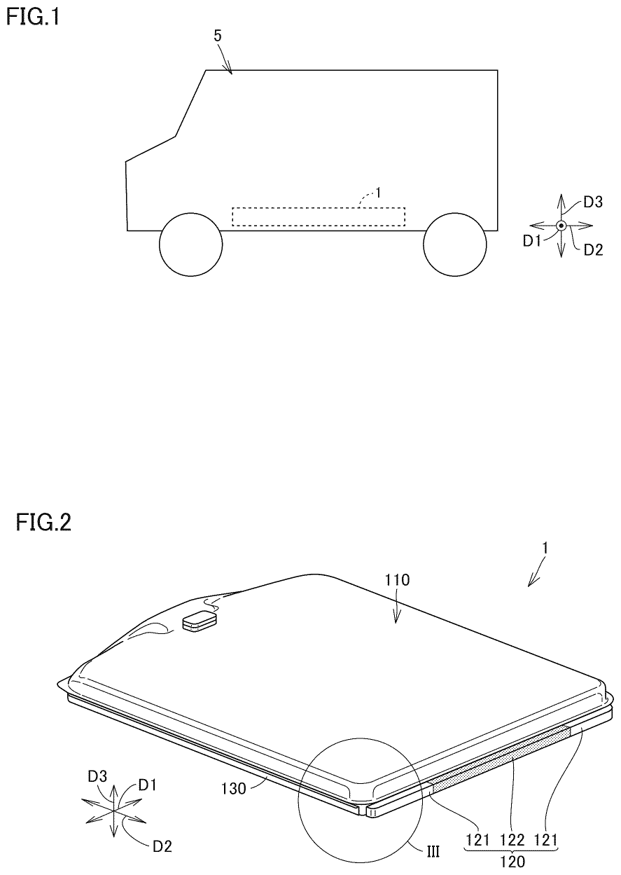

FIG. 1 is a schematic diagram illustrating a state in which a power storage device according to an embodiment of the present disclosure is mounted on a vehicle. The power storage device 1 may be mounted on a vehicle 5. The vehicle 5 is, for example, a battery electric vehicle (BEV). The vehicle 5 may be another type of electric vehicle, such as a plug-in hybrid vehicle (PHEV).

When the power storage device 1 is mounted on the vehicle 5, a first direction D1 of the power storage device 1 is typically the left-right direction of the vehicle 5. A second direction D2 of the power storage device 1 is typically the front-rear direction of the vehicle 5. A third direction D3 of the power storage device 1 is typically the vertical direction.

The second direction D2 intersects the first direction D1. Specifically, the second direction D2 is orthogonal to the first direction D1. The third direction D3 intersects both the first direction D1 and the second direction D2. Specifically, the third direction D3 is orthogonal to both the first direction D1 and the second direction D2.

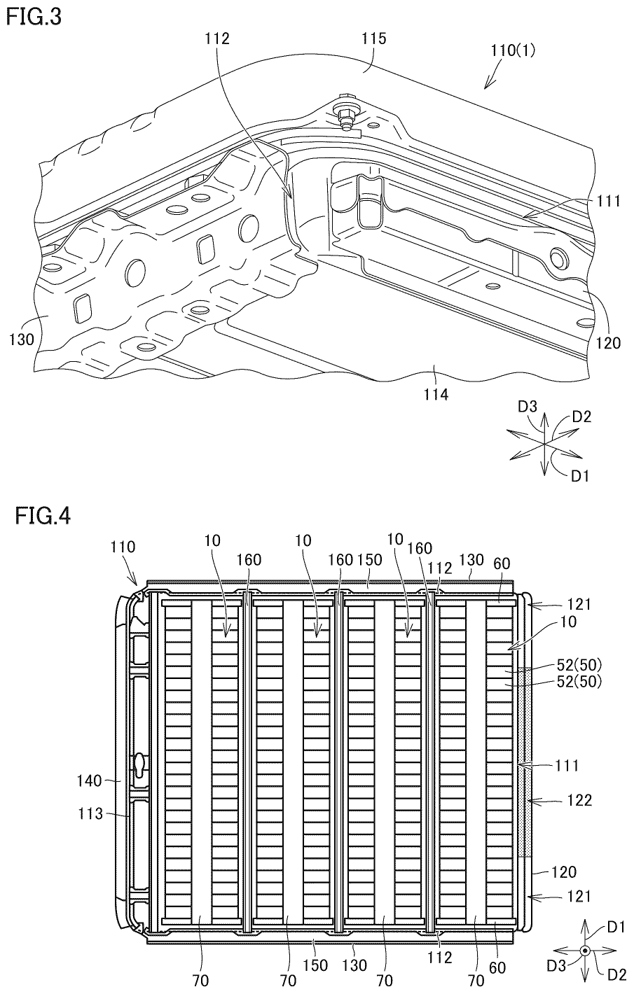

FIG. 2 is a perspective view illustrating a power storage device according to an embodiment of the present disclosure. FIG. 3 is a partial perspective view illustrating a region III of FIG. 2 from a different angle. FIG. 4 is a schematic plan view partially illustrating an internal structure of the power storage device.

As illustrated in FIGS. 2 to 4, the power storage device 1 includes a plurality of power storage modules 10 and a case 110.

As illustrated in FIG. 4, the plurality of power storage modules 10 are aligned in the second direction D2. In the present embodiment, the plurality of power storage modules 10 are aligned only in the second direction D2.

Each of the plurality of power storage modules 10 includes a plurality of cells 50, a pair of end plates 60, and a restraining member 70.

The plurality of cells 50 are stacked on each other in the first direction D1. Preferably, the plurality of cells 50 are directly stacked on each other. Thus, the energy density of the power storage module 10 can be improved. The plurality of cells 50 may be stacked on each other with a spacer interposed between the cells 50 adjacent to each other. The pair of end plates 60 are disposed on both sides of the entire plurality of cells 50 in the first direction D1. The restraining member 70 applies a predetermined restraining force in the first direction D1 to the plurality of cells 50 and the pair of end plates 60 stacked on each other.

FIG. 5 is an exploded perspective view of a cell. As illustrated in FIG. 5, each cell 50 includes an electrode assembly 51 and a cell case 52. Each cell 50 is, for example, a non-aqueous electrolyte secondary battery such as a lithium ion secondary battery.

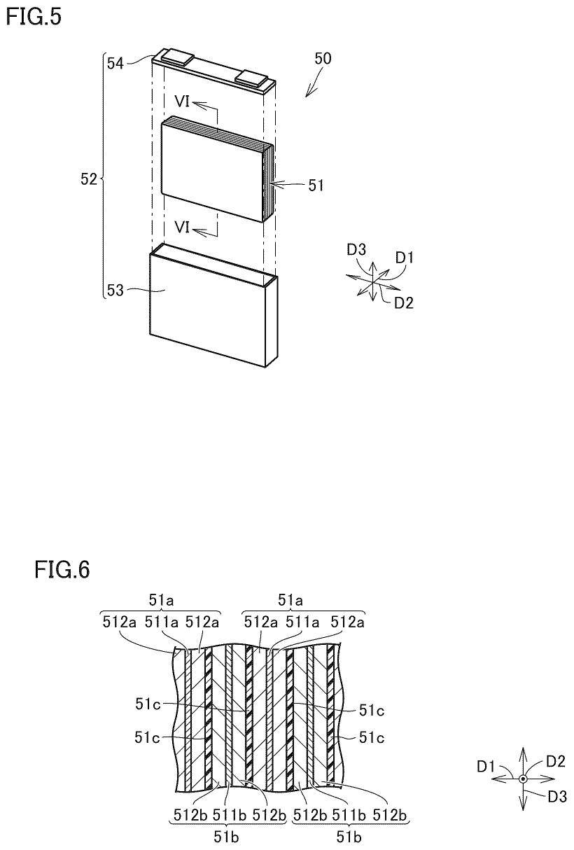

FIG. 6 is a partial cross-sectional view illustrating the electrode assembly of FIG. 5 taken along line VI-VI. As illustrated in FIGS. 5 and 6, the electrode assembly 51 includes a positive electrode layer 51a, a negative electrode layer 51b, and a separator 51c. The positive electrode layer 51a and the negative electrode layer 51b are stacked in the first direction D1 with the separator 51c interposed therebetween.

In the present embodiment, the positive electrode layer 51a includes a positive electrode current collector foil 511a and a positive electrode active material layer 512a. The positive electrode active material layer 512a is disposed on both surfaces of the positive electrode current collector foil 511a.

The negative electrode layer 51b includes a negative electrode current collector foil 511b and a negative electrode active material layer 512b. The negative electrode active material layer 512b is disposed on both surfaces of the negative electrode current collector foil 511b.

The separator 51c insulates the positive electrode layer 51a and the negative electrode layer 51b from each other. The separator 51c is made of an insulating material, and contains minute voids to allow ions to pass therethrough.

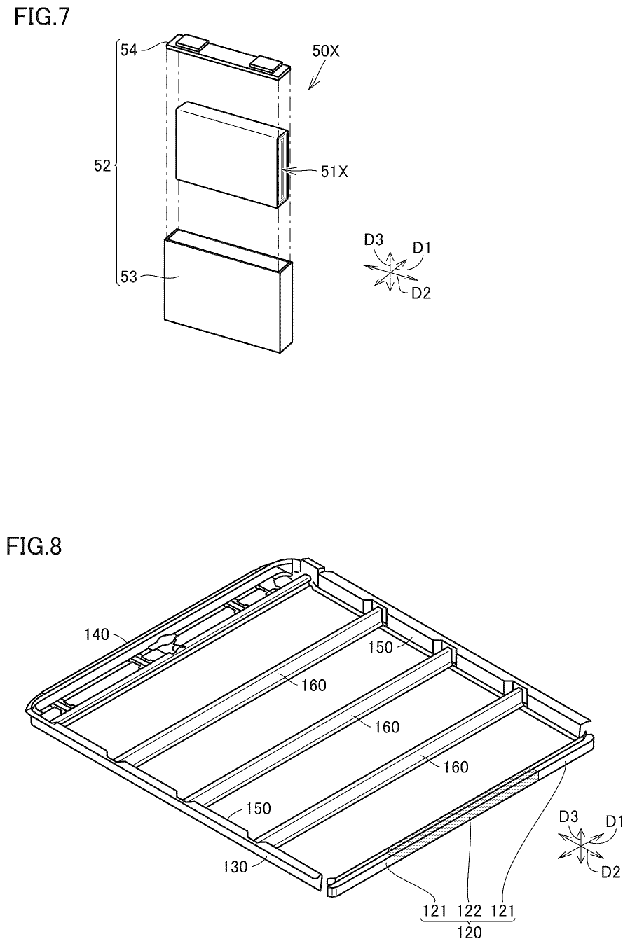

The electrode assembly 51 is not limited to the configuration described above. FIG. 7 is an exploded perspective view illustrating a cell according to a modification. As illustrated in FIG. 7, the electrode assembly 51X may be wound about an axis in the second direction D2. In the electrode assembly 51X wound as described above, the separator 51c is interposed between the positive electrode layer 51a and the negative electrode layer 51b.

The cell case 52 houses the electrode assembly 51. The cell case 52 may further house an electrolytic solution (not shown).

The cell case 52 has a substantially rectangular parallelepiped outer shape. The cell 50 in the present embodiment is a so-called square battery. The size of the cell case 52 in the first direction D1 is smaller than the size thereof in the second direction D2 and the size thereof in the third direction D3. The size of the cell case 52 in the second direction D2 is greater than the size thereof in the first direction D1 and the size thereof in the third direction D3.

The cell case 52 includes a cell case main body 53 and a lid 54. The cell case main body 53 has an opening facing one side of the third direction D3. The lid 54 closes the opening. The cell case main body 53 may have one or more openings facing one side or both sides of the second direction D2.

As illustrated in FIGS. 2 to 4, the case 110 houses a plurality of power storage modules 10. The case 110 includes a first wall 111, a pair of second walls 112, a third wall 113, a bottom 114, a cover 115, a first reinforcing member 120, a pair of second reinforcing members 130, and a third reinforcing member 140.

The first wall 111 is located at least on one side of the power storage module 10 in the second direction D2. Specifically, the first wall 111 is located on one side of the entire plurality of power storage modules 10 in the second direction D2. The first wall 111 extends in the first direction D1. The first wall 111 is longer than each of the plurality of power storage modules 10 in the first direction D1.

The pair of second walls 112 are located on both sides of the power storage module 10 in the first direction D1, respectively. The pair of second walls 112 are located on both sides of the entire plurality of power storage modules 10 in the first direction D1, respectively. The pair of second walls 112 extends along the second direction D2. The pair of second walls 112 is longer than the entire plurality of power storage modules 10 in the second direction D2. The pair of second walls 112 are connected to both ends of the first wall 111 in the first direction D1, respectively. The pair of second walls 112 is integrally formed with the first wall 111.

The third wall 113 is located on the other side of the power storage module 10 in the second direction D2. Specifically, the third wall 113 is located on the other side of the entire plurality of power storage modules 10 in the second direction D2.

The third wall 113 extends in the first direction D1. The third wall 113 is longer than each of the plurality of power storage modules 10 in the first direction D1. The pair of second walls 112 are connected to both ends of the third wall 113 in the first direction D1, respectively. The third wall 113 is integrally formed with both of the pair of second walls 112.

The bottom 114 covers one side of the plurality of power storage modules 10 in the third direction D3. The bottom 114 covers a lower surface of the plurality of power storage modules 10. The bottom 114 is connected to the first wall 111. The bottom 114 is integrally formed with the first wall 111. The bottom 114 is connected to the pair of second walls 112. The bottom 114 is integrally formed with the pair of second walls 112. The bottom 114 is connected to the third wall 113. The bottom 114 is integrally formed with the third wall 113.

The cover 115 covers the other side of the plurality of power storage modules 10 in the third direction D3. The cover 115 is connected to the first wall 111, the pair of second walls 112, and the third wall 113. The cover 115 is fastened to the first wall 111, the pair of second walls 112, and the third wall 113 by fasteners (not shown) such as screws.

The case 110 (including the first wall 111, the pair of second walls 112, the third wall 113, the bottom 114, and the cover 115) is made of metal, for example. Specifically, the case 110 is formed of a steel plate. The first wall 111, the pair of second walls 112, the third wall 113, and the bottom 114 may be formed of a single steel plate by press working or the like. Therefore, the thicknesses of the first wall 111, the thicknesses of the pair of second walls 112, the thicknesses of the third wall 113, and the thicknesses of the bottom 114 may be substantially equal to each other.

The first reinforcing member 120 is provided on the first wall 111. The first reinforcing member 120 extends in the first direction D1.

The first reinforcing member 120 is more rigid than the first wall 111 and the pair of second walls 112. For example, the first reinforcing member 120 may be formed of a material having a Young's modulus greater than that of the first wall 111 and the pair of second walls 112. The first reinforcing member 120 may be formed of a material having a yield strength smaller than that of the first wall 111 and the pair of second walls 112. The first reinforcing member 120 may have a second moment of area lower than that of the first wall 111 and the pair of second walls 112. The first reinforcing member 120 may have a bending rigidity lower than that of the first wall 111 and the pair of second walls 112. The first reinforcing member 120 may be formed of a material having a tensile strength smaller than that of the first wall 111 and the pair of second walls 112.

The first reinforcing member 120 includes a pair of first regions 121 and a second region 122. The pair of first regions 121 extend in the first direction D1, respectively. The pair of first regions 121 include both ends of the first reinforcing member 120 in the first direction D1, respectively.

The second region 122 is aligned with the first region 121 in the first direction D1. Specifically, the second region 122 is disposed between the pair of first regions 121. The second region 122 extends in the first direction D1. The second region 122 of the first reinforcing member 120 is located on the outer surface of the first wall 111 in the middle of the first direction D1. The length of the second region 122 in the first direction D1 is half or more of the length of the first reinforcing member 120.

The second region 122 is less rigid than the first region 121. The method of making the second region 122 less rigid than the first region 121 is not particularly limited. In the present embodiment, the second region 122 may be formed of a material having a Young's modulus smaller than that of the first region 121. The second region 122 may be formed of a material having a yield strength smaller than that of the first region 121. The second region 122 may have a second moment of area lower than that of the first region 121. The second region 122 may have a bending rigidity lower than that of the first region 121.

The second region 122 may be formed of a material having a tensile strength lower than that of the first region 121. Specifically, the pair of the first region 121 and the second region 122 may be formed of a plate-processed steel plate. The pair of the first region 121 and the second region 122 may be formed of a hot-dip galvanized steel sheet. The tensile strength of the hot-dip galvanized steel sheet constituting the pair of first regions 121 is preferably, for example, 440 MPa or more. The tensile strength of the hot-dip galvanized steel sheet constituting the second region 122 is, for example, less than 440 MPa and preferably 270 MPa or more. The tensile strength of the material constituting the first region 121 may be 1.1 times or more, 1.2 times or more, or 1.5 times or more than the tensile strength of the material constituting the second region 122.

The pair of second reinforcing members 130 are provided on the pair of second walls 112, respectively. The pair of second reinforcing members 130 are spaced apart from the first reinforcing member 120.

The pair of second reinforcing members 130 is more rigid than the first wall 111 and the pair of second walls 112. For example, the second reinforcing member 130 may be formed of a material having a Young's modulus greater than that of the material constituting the first wall 111 and the pair of second walls 112. The second reinforcing member 130 may be formed of a material having a yield strength greater than that of the first wall 111 and the pair of second walls 112. The second reinforcing member 130 may have a second moment of area higher than that of the first wall 111 and the pair of second walls 112. The second reinforcing member 130 may have a bending rigidity higher than that of the first wall 111 and the pair of second walls 112. The second reinforcing member 130 may be formed of a material having a tensile strength higher than that of the first wall 111 and the pair of second walls 112.

The second region 122 is less rigid than the pair of second reinforcing members 130. The method of making the second region 122 less rigid than the pair of second reinforcing members 130 is not particularly limited. In the present embodiment, the second region 122 may be formed of a material having a Young's modulus smaller than that of the pair of second reinforcing members 130. The second region 122 may be formed of a material having a yield strength smaller than that of the pair of second reinforcing members 130. The second region 122 may have a second moment of area lower than that of the pair of second reinforcing members 130. The second region 122 may have a bending rigidity lower than that of the pair of second reinforcing members 130.

The second region 122 may be formed of a material having a tensile strength lower than that of the pair of second reinforcing members 130. Specifically, the pair of second reinforcing members 130 may be formed of a hot-dip galvanized steel sheet. The tensile strength of the hot-dip galvanized steel sheet constituting the pair of first regions 121 is preferably, for example, 440 MPa or more.

The third reinforcing member 140 is provided on the third wall 113. The third reinforcing member 140 extends in the first direction D1. The third reinforcing member 140 is spaced apart from the pair of second reinforcing members 130.

The third reinforcing member 140 is more rigid than the third wall 113 and the pair of second walls 112. For example, the third reinforcing member 140 may be formed of a material having a Young's modulus greater than that of the third wall 113 and the pair of second walls 112. The third reinforcing member 140 may be formed of a material having a yield strength greater than that of the third wall 113 and the pair of second walls 112. The third reinforcing member 140 may have a second moment of area higher than that of the third wall 113 and the pair of second walls 112. The third reinforcing member 140 may have a bending rigidity higher than that of the third wall 113 and the pair of second walls 112. The third reinforcing member 140 may be formed of a material having a tensile strength higher than that of the third wall 113 and the pair of second walls 112.

The second region 122 is less rigid than the third reinforcing member 140. The method of making the second region 122 less rigid than the third reinforcing member 140 is not particularly limited. In the present embodiment, the second region 122 may be formed of a material having a Young's modulus smaller than that of the third reinforcing member 140. The second region 122 may be formed of a material having a yield strength smaller than that of the third reinforcing member 140. The second region 122 may have a second moment of area lower than that of the third reinforcing member 140. The second region 122 may have a bending rigidity lower than that of the third reinforcing member 140.

The second region 122 may be formed of a material having a tensile strength lower than that of the third reinforcing member 140. Specifically, the third reinforcing member 140 may be formed of a hot-dip galvanized steel sheet. The tensile strength of the hot-dip galvanized steel sheet constituting the third reinforcing member 140 is preferably, for example, 440 MPa or more.

FIG. 8 is a schematic perspective view partially illustrating the configuration of a power storage device. As illustrated in FIGS. 4 and 8, the case 110 further includes a pair of inner side frames 150 and a plurality of inner cross frames 160.

The pair of inner side frames 150 are housed inside the case 110. In other words, the pair of inner side frames 150 are located inside the pair of second walls 112, respectively. The pair of inner side frames 150 are located on both sides of the entire plurality of power storage modules 10 in the second direction D2, respectively.

The plurality of inner cross frames 160 extend along the first direction D1. The plurality of internal cross frames 160 are spaced apart from each other in the second direction D2. Both ends of the plurality of internal cross frames 160 are connected to the pair of internal side frames 150, respectively. The inner cross frame 160 may be connected to the inner side frame 150 by fastening using a fastening member such as a bolt, by welding, or by caulking. The plurality of power storage modules 10 are arranged in the second direction D2 with the internal cross frame 160 interposed therebetween.

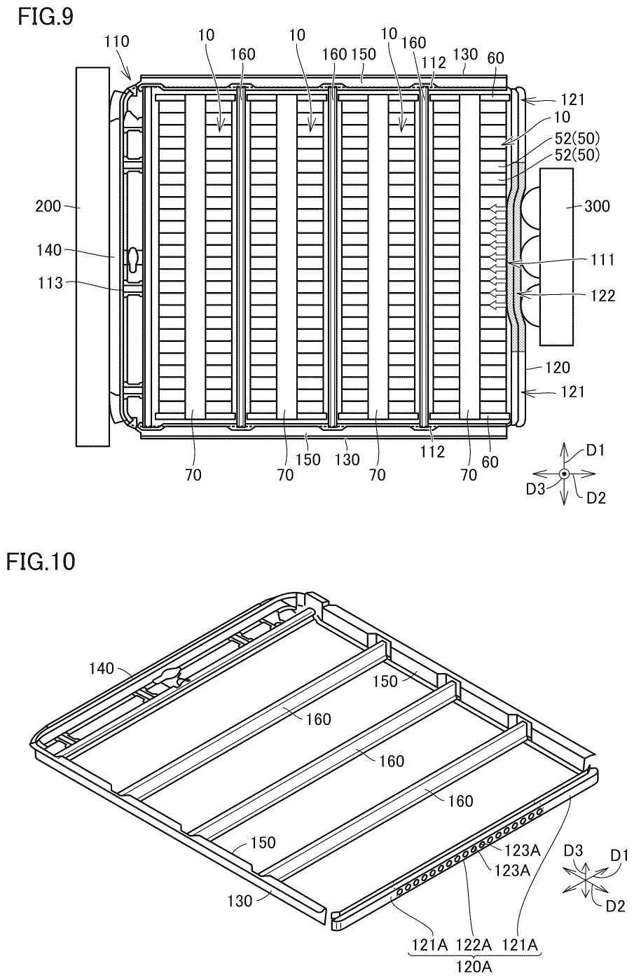

Hereinafter, the deformation of the power storage device 1 when a load is applied to the power storage device 1 from one side of the second direction D2 (the side of the first reinforcing member 120) will be described. FIG. 9 is a schematic plan view illustrating a power storage device to which a load is applied. Similarly to FIG. 4, FIG. 9 partially illustrates an internal structure of the power storage device 1.

FIG. 9 illustrates the power storage device 1 in such a state that one side of the power storage device 1 in the second direction D2 is supported by the support member 200, and the other side of the power storage device 1 in the second direction D2 is pressed by the pressing member 300.

As described above, in the present embodiment, the second region 122 is less rigid than the first region 121. Accordingly, as illustrated in FIG. 9, when a load is applied to the second region 122 of the first reinforcing member 120 from one side of the second direction D2, the entire second region 122 is displaced in the second direction D2 toward the power storage module 10. The displaced second region 122 comes into contact with the plurality of cells 50 stacked in the first direction D1 together with the first wall 111. Therefore, the load applied to the second region 122 of the first reinforcing member 120 can be distributed to the plurality of cells 50. More specifically, the load can be distributed to the plurality of cell cases 52.

In other words, according to the configuration described above, it is possible to prevent the first reinforcing member 120 from being deformed in an arc shape with the pair of second walls 112 acting as fulcrums. Thus, it is possible to prevent a local load from being applied to the cells 50 of the power storage module 10 by the deformed first reinforcing member 120 and the first wall 111.

Further, the second region 122 of the first reinforcing member 120 is located on the outer surface of the first wall 111 in the middle of the first direction the first direction D1.

According to the configuration described above, since the second region 122 is located at a position relatively far from the pair of second walls 112, the entire second region 122 is more easily displaced when a load is applied to the second region 122. Accordingly, it is possible to further prevent the first reinforcing member 120 and the first wall 111 from being deformed in an arc shape. The load applied to the second region 122 of the first reinforcing member 120 may be dispersed by the plurality of cells.

Further, the length of the second region 122 in the first direction D1 is half or more of the length of the first reinforcing member 120.

According to the configuration described above, even when the position of a maximum load applied to the first reinforcing member 120 is unevenly distributed in the first direction D1, the entire second region 122 may be displaced by the load applied to the first reinforcing member 120. Therefore, the load applied to the first reinforcing member 120 can be effectively distributed to the plurality of cells.

Further, the pair of second reinforcing members 130 is more rigid than the first wall 111 and the pair of second walls 112. The second region 122 is less rigid than the pair of second reinforcing members 130.

According to the configuration described above, the strength of the second wall 112 can be improved by the second reinforcing member 130, and thereby the strength of the case 110 can be improved. Since the first reinforcing member 120 includes the second region which is less rigid than the second reinforcing member 130, it is possible to prevent the first reinforcing member 120 from being deformed in an arc shape with the pair of second reinforcing members 130 acting as fulcrums.

Further, the pair of second reinforcing members 130 is spaced apart from the first reinforcing member 120. According to this configuration, it is possible to further prevent the first reinforcing member 120 from being deformed in an arc shape with the pair of second reinforcing members 130 acting as fulcrums.

Further, the third reinforcing member 140 is more rigid than the third wall 113 and the pair of second walls 112. The second region 122 is less rigid than the third reinforcing member 140.

According to the configuration described above, it is possible to improve the rigidity of the entire case 110 in the first direction D1. When a load is applied from the side of the third reinforcing member 140 in the second direction D2, the second region 122 of the first reinforcing member 120 is deformed, which prevents the third reinforcing member 140 and the third wall 113 from being deformed in an arc shape.

Further, in each of the plurality of cells 50, the positive electrode layer 51a and the negative electrode layer 51b may be stacked in the first direction D1 with the separator 51c interposed therebetween.

When the cell 50 having the above-described configuration is compressed to deform in the second direction D2, an internal short circuit is likely to occur. However, since the load applied to one cell 50 is reduced by the second region 122, the compressive deformation in the second direction D2 is prevented. Therefore, it is possible to prevent an internal short circuit from occurring in the cell 50.

Further, in each of the plurality of cells 50X, the electrode assembly 51X may be wound about an axis in a direction orthogonal to the first direction D1. More specifically, the electrode assembly 51X may be wound about an axis in the second direction D2.

When the cell 50X having the above-described configuration is compressed to deform in a direction (the second direction D2) orthogonal to the first direction D1, an internal short circuit is likely to occur. However, since the load applied to one cell 50X is reduced by the second region 122, the compressive deformation in a direction (the second direction D2) orthogonal to the first direction D1 is prevented. Therefore, it is possible to prevent an internal short circuit from occurring in the cell 50X.

The second region 122 may be made less rigid than the first region 121, the second reinforcing member 130, and the third reinforcing member 140 by various methods.

FIG. 10 is a perspective view partially illustrating a configuration of a power storage device according to a modification. As illustrated in FIG. 10, a plurality of through holes 123A may be formed in the second region 122A of the first reinforcing member 120A. Accordingly, the second region 122A may be less rigid than the first region 121A, the second reinforcing member 130, and the third reinforcing member 140. In this case, the Young's modulus or the like of the material constituting the second region 122A may not be smaller than the Young's modulus or the like of the material constituting each of the first region 121A, the second reinforcing member 130, and the third reinforcing member 140.

In the present modification, the plurality of through holes 123A are formed to penetrate the first reinforcing member 120A in the second direction D2. The plurality of through holes 123A may be formed to penetrate the first reinforcing member 120A in the third direction D3. A plurality of through holes may also be formed in the first region 121A, but the diameter of each through hole formed in the first region 121A is preferably smaller than that of each through hole 123A. The distance between the plurality of through holes formed in the first region 121A is preferably greater than the distance between the plurality of through holes 123A in the first direction D1.

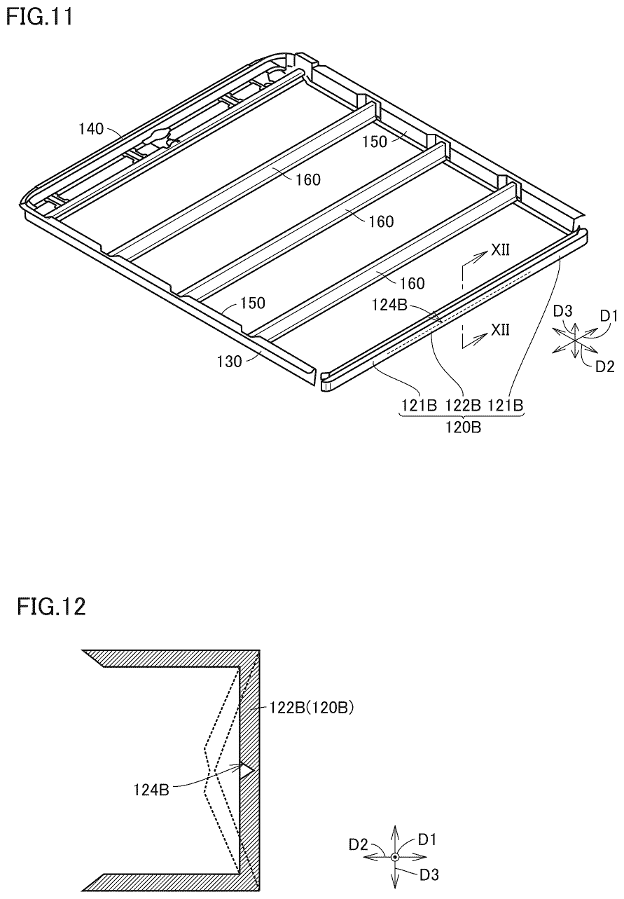

FIG. 11 is a perspective view partially illustrating a configuration of a power storage device according to another modification. FIG. 12 is a schematic cross-sectional view illustrating a first reinforcing member of FIG. 11 taken along line XII-XII. As illustrated in FIGS. 11 and 12, a notch 124B extending along the first direction D1 may be formed in the second region 122B of the first reinforcing member 120B. Thus, the second region 122B may be less rigid than the first region 121B and the second reinforcing member 130. As illustrated by the broken line in FIG. 12, when a load is applied from one side of the second direction D2, the second region 122B buckles around the notch 124B. In this case, the Young's modulus or the like of the material constituting the second region 122B may not be smaller than the Young's modulus or the like of the material constituting each of the first region 121B, the second reinforcing member 130, and the third reinforcing member 140.

In the present modification, the notch 124B does not penetrate the first reinforcing member 120B, but it may penetrate the first reinforcing member 120B. The notch 124B is provided on the first reinforcing member 120B on one side of the case 110, but it may be provided on the first reinforcing member 120B on the other side of the case 110.

In the embodiments described above, proper combinations of components in each embodiment are also originally intended.

Although the embodiments of the present disclosure have been described, it should be understood that the embodiments disclosed herein have been presented for the purpose of illustration and description but not limited in all aspects. It is intended that the scope of the present disclosure is not limited to the description above but defined by the scope of the claims and encompasses all modifications equivalent in meaning and scope to the claims.

What is claimed is:

1. A power storage device comprising:
a power storage module that includes a plurality of cells stacked on each other in a first direction; and
a case that houses the power storage module,
wherein the case includes:
a first wall which is located at least on one side of the power storage module in a second direction that intersects the first direction and extends along the first direction;
a pair of second walls which are located on both sides of the power storage module in the first direction, respectively, extend along the second direction, and are connected to both ends of the first wall, respectively; and
a first reinforcing member which is provided on the first wall, extends along the first direction, and is more rigid than the first wall and the pair of second walls,
the first reinforcing member includes:
a first region which extends in the first direction; and
a second region which is aligned with the first region in the first direction and extends in the first direction, and
the second region is less rigid than the first region.

2. The power storage device according to claim 1, wherein
the second region of the first reinforcing member is located on an outer surface of the first wall in the middle of the first direction.

3. The power storage device according to claim 1, wherein
a length of the second region in the first direction is half or more of a length of the first reinforcing member.

4. The power storage device according to claim 1, wherein
the case further includes a pair of second reinforcing members,
the pair of second reinforcing members are provided on the pair of second walls, respectively, extend along the second direction, and are more rigid than the first wall and the pair of second walls, and
the second region is less rigid than the pair of second reinforcing members.

5. The power storage device according to claim 4, wherein
the pair of second reinforcing members is spaced apart from the first reinforcing member.

6. The power storage device according to claim 1, wherein
the case further includes a third wall,
the third wall is located on the other side of the power storage module in the second direction and extends along the first direction,
the pair of second walls are connected to both ends of the third wall, respectively,
the case further includes a third reinforcing member,
the third reinforcing member is provided on the third wall, extends along the first direction, and is more rigid than the third wall and the pair of second walls, and
the second region is less rigid than the third reinforcing member.

7. The power storage device according to claim 1, wherein
each of the plurality of cells includes:
an electrode assembly that includes a positive electrode layer, a negative electrode layer, and a separator; and
a cell case that houses the electrode assembly,
the positive electrode layer and the negative electrode layer are stacked in the first direction with the separator interposed therebetween.

8. The power storage device according to claim 1, wherein
each of the plurality of cells includes:
an electrode assembly that includes a positive electrode layer, a negative electrode layer, and a separator interposed between the positive electrode layer and the negative electrode layer; and
a cell case that houses the electrode assembly,
the electrode assembly is wound about an axis in a direction orthogonal to the first direction.

9. The power storage device according to claim 2, wherein
a length of the second region in the first direction is half or more of a length of the first reinforcing member.
